(19) United States
(12) Patent Application Publication
(10) Pub. No.: US 2009/0301983 A1
(43) Pub. Date: Dec. 10, 2009

(54) Crane for handling of chains,wires,etc., and tools for same

(76) Inventor: Johnny Lorgen, Brattvag (NO)

Correspondence Address: ABELMAN, FRAYNE & SCHWAB, 666 THIRD AVENUE, 10TH FLOOR, NEW YORK, NY, 10017, US

(21) Appl. No.: 11/920,932

(22) PCT Filed: May 15, 2006
(86) PCT No.: PCT/NO2006/000179

§ 371 Date: Mar. 23, 2009

(30) Foreign Application Priority Data
May 20, 2005 (NO) 20052433

(51) Int. Cl. B66C 23/66

(52) U.S. Cl. 212/292

(57) ABSTRACT

The invention relates to a crane (10) for handling of chains, wires, shackles, messengers, etc., onboard a vessel, where one or more cranes (10) is arranged on or adjoining the deck of the vessel, and where each crane comprises a base part (12) with an associated main jib (14) that is arranged to be driven by a number of pressure cylinders (26). At least two rotary work jibs (16,18) arranged to be driven separately by associated pressure cylinders (28,30) are arranged to the outwardly extending end (15) of the main jib (14), and tools (34,22,24) are arranged to the outwardly extending ends (17,19) of said work jibs (16,18), for the mutual handling of said chains, wires, shackles, messengers, etc.

The present invention relates to a crane for handling of chains, wires, shackles, messengers, etc., onboard a vessel, where one or more cranes are arranged on or adjoining the deck of the vessel, and where the crane comprises a base part with an associated main jib that is arranged to be driven by a number of pressure cylinders. The invention also relates to a tool for handling of chains, wires, etc., onboard a vessel.

The present invention is developed from the point of view of contributing to ensuring that the working situations for deckhands on the work deck of anchor handling vessels shall be safer. A consequence is therefore that many working methods will be changed, and for this reason the different working situations for the deckhands become safer and easier to perform. The tendency over the last years has been that newly developed equipment that shall be placed on the bottom, has come in addition to the anchor handling itself. Therefore, the equipment that shall be handled has changed in extent and size after the rig activities have moved to deeper waters. The need for an anchor handling vessel that shall be able to carry out the many different tasks, has led to equipment that can tackle different situations also being added to the work deck, and therefore the equipment (the tool) on the work deck must also be designed in such a way that it does not get in the way, but rather is useful for operations other than anchor handling.

The development within anchor handling goes towards heavier and heavier equipment, at the same time as increased focus is given to the safety of the crew that works on deck. This means that there is a requirement for equipment and tools that can lead to the work being safer. With the present invention, a new type of crane has been constructed which, for one thing, is intended to carry out anchor handling, and other tasks on a vessel. The new crane is constructed to carry out operations that hitherto have been too risky and heavy to do manually. With the help of remote control, the work operations can be controlled by crews on deck from a safe position that offers a good view.

According to the invention, an anchor handling crane can be mounted on each side of a work deck of a vessel. The cranes can move longitudinally along the ship on tracks, for example, on the top of the cargo rail. Both the cranes can rotate 360 degrees and can therefore have access to the whole of the work deck, behind the stern roller, outside the side of the vessel and across two winches at the forward area of the deck. The cranes are, in the main, equipped with a main jib and two work jibs that can be used independently of each other. The work jib that is not in use can be folded in under the main jib and is thereby not in the way of the other.

From prior art, U.S. Pat. No. 4,197,953 among others, shall be described where a crane construction is described with two rotary crane jibs. From U.S. Pat. No. 5,626,013 a material handling system is known comprising a system with several cranes that are telescopic and that have tools arranged on their extending ends. WO 01/51762 concerns a pipe handling system where a tool is used for holding the pipes fast, and where the tool comprises two arms that are arranged to pick up, hold fast and/or release the pipes. None of the known documents show that the work jibs are arranged on the main jib of the crane, or a tool as defined mounted on a crane.

It is an object of the present invention to provide a solution which, for one thing, leads to that work operations can be carried out all along the deck; that it is easy to get access in all directions; reduces or removes the need for other cranes and above all results in the work onboard becoming safer.

The above mentioned objects are achieved with a crane as defined in the characteristic part of the independent claim 1, in that at least two rotary work jibs are arranged to the outwardly extending end of the main jib, arranged to be driven independently by associated pressure cylinders, and that tools for mutual handling of said chains, wires, shackles, messengers, etc., are arranged to the outwardly extending ends of said work jibs.

Alternative embodiments are defined in the dependent claims 2-13. Said at least two work jibs, are preferably arranged side by side on the outwardly extending end of the main jib. A first work jib preferably comprises a winch or winch wheel for the carrying out of lifting operations, and also a hooking tool that can be closed to pick up, release and/or push said chains, wires, etc. The hooking tool of the first work jib can be formed as an extension of the outwardly extending end of the jib, and comprise a hook-formed body that is arranged to be pulled in and be pushed out of said extension.

Alternatively, the extension can be designed as a long pipe-formed body mounted to, or integrated with, the outwardly extending end, and comprise a through groove that runs, at least partially, in the longitudinal direction of the body, where, in or to the extension, a mechanism is arranged that is adapted to rotate the hook-formed body from a retracted and inactive position to a extended and active position. Said mechanism can be arranged inside the pipe-formed body, and comprise a closed articulated connection coupled to a pressure cylinder, with the hook-formed body fastened to one of the joints in the articulated connection, so that the hook-formed body can be brought from the inactive position to an active, hooking position and possibly further to an active, locking position.

A second work jib preferably comprises at least one of a chain claw and a wire twister, where the chain claw is adapted to grip and hold chains, chain loops, shackles, etc., and where the wire twister is arranged to grip and hold a wire or the like, and also, turn, lift and/or move said wire.

The chain claw is preferably formed, at least partially, in a U-shape, comprising an upper, moveable jaw part and a lower stationary jaw part, to receive and hold fast a chain or the like. The upper jaw part can be connected articulately in an area adjoining an inner part of the chain claw, and the upper jaw part can comprise a tooth-like protrusion arranged to fit into a link of a chain. The upper jaw part is preferably driven by a pressure cylinder.

The wire twister preferably comprises a rotary, mounted body with a lower part with a longitudinal groove or cut out arranged to receive and hold fast a wire or the like. Furthermore, the wire twister can comprise a number of pressure cylinders or pistons to hold fast the wire, and also a pressure cylinder to rotate said body.

At least one of the said tools is, in a preferred embodiment, fastened to a rotary and flippable tool anchorage point at the end of the second work jib.

Furthermore, the crane can comprise equipment for remote control of the crane or cranes.

The invention also relates to tools as defined in the claims 14-20, where the tools are in accordance with what is mentioned above.

The invention shall now be described in more detail with reference to the enclosed figures, in which:

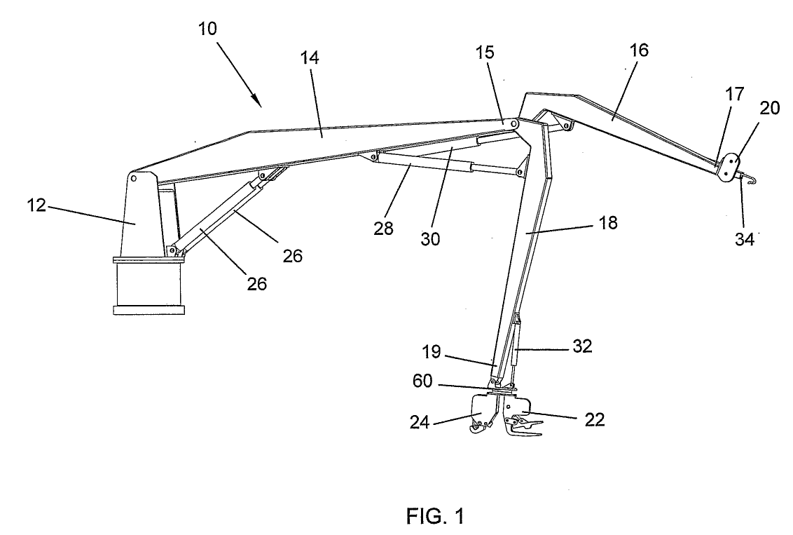

FIG. 1 shows a crane according to the invention.

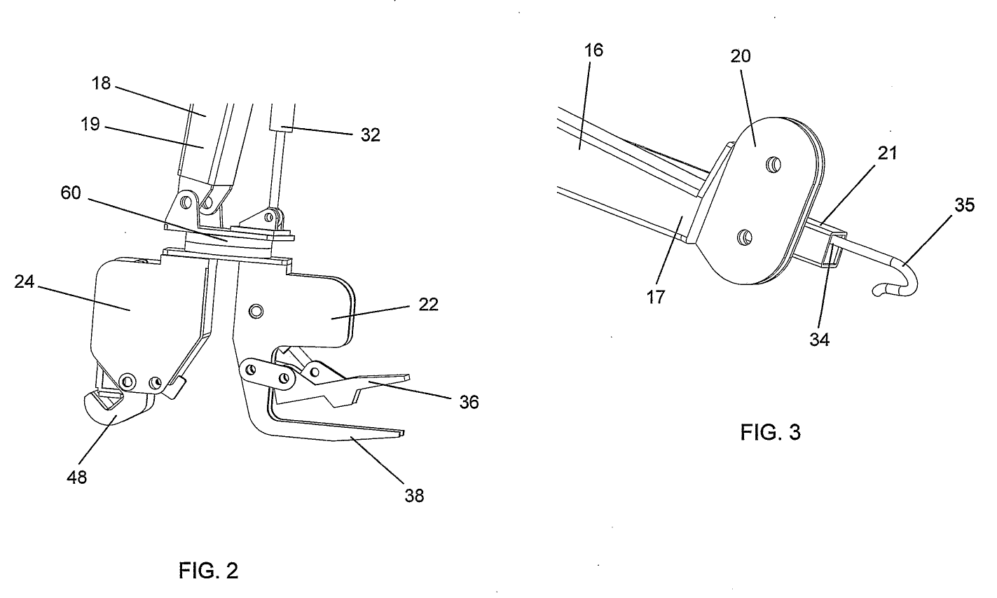

FIG. 2 shows a section of a tool mounted to an outer part of one of the jibs of the crane according to the invention.

FIG. 3 shows a section of a tool mounted to an outer part of another of the crane's jibs according to the invention.

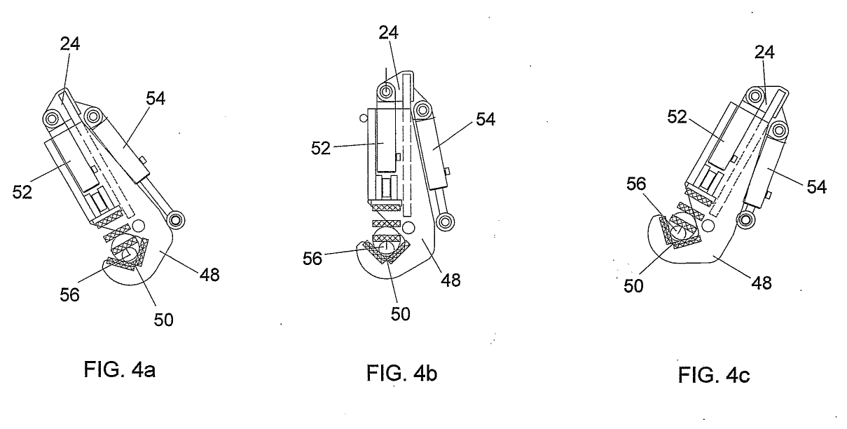

FIGS. 4a-4c shows details of a wire twister mounted to one of the jibs of the crane, according to the invention, in different positions.

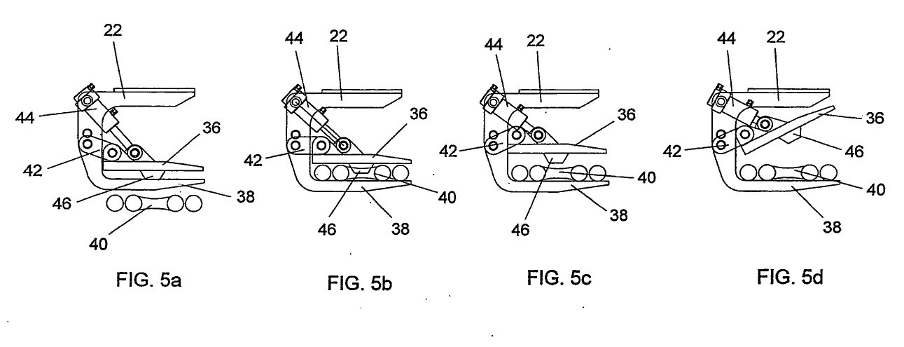

FIGS. 5a-5d shows details of a chain claw mounted to one of the jibs of the crane, according to the invention, in different positions.

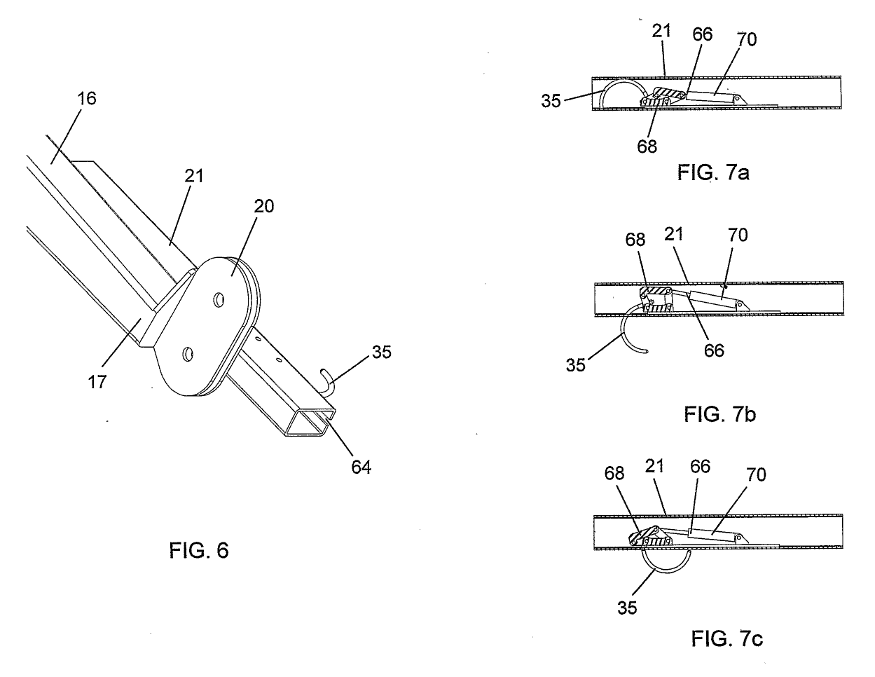

FIG. 6 shows an alternative embodiment of a tool mounted to an outer part of one the jibs of the crane, according to the invention.

FIGS. 7a-7d shows details of the tool shown in FIG. 6, in different positions.

FIG. 1 shows a crane 10, a so-called anchor handling crane, for installation on or adjoining a work deck on a vessel. The crane 10 comprises a base part 12 and a main jib 14 that is driven in a traditional way by one or more pressure cylinders 26, such as hydraulic cylinders. As mentioned, an anchor handling crane 10 according to the invention can be mounted on each side of a work deck on a vessel. The crane or cranes can move along the ship in tracks, for example on the top of the cargo rail, and the base part 12 can consequently comprise equipment that makes such movement possible. The crane can rotate 360 degrees, and can therefore have access to the whole of the work deck, behind the stern roller, outside the side of the ship and across the winches at the front of the deck. It shall be mentioned that even if the expression “anchor handling crane” is being used, the crane or the cranes are not limited to just the anchor handling, but can also be used to carry out other work operations onboard the vessel.

At least two work jibs 16, 18 are arranged to the outwardly extending end 15 of the main jib 14, that each can be driven separately with the help of their own pressure cylinder 28, 30, such as hydraulic cylinders. The work jibs 16, 18 are arranged side by side and can be rotated about their mounting points, i.e. being hoisted and lowered as desired or if a work jib is not in use it can be folded and be placed by the main jib 14 so that it is not in the way for work that the other work jib is carrying out. Correspondingly, both work jibs 16, 18 can, of course, be retracted if the crane 10 is not in use. Furthermore, the crane 10 can be fitted with equipment for remote control of the crane and associated components.

The outwardly extending end 17 of the first work jib 16 preferably comprises winch equipment 20 and also a hooking tool 34, as shown in FIG. 3. FIG. 2 shows the outwardly extending end 19 of the second work jib 18, comprising a chain claw 22 and a wire twister 24. Furthermore, at least one of said tools 22,24 is fastened to a rotary and flippable tool anchorage point 60 at the end 19 of the second work jib 18.

In an alternative embodiment (not shown) more than two work jibs, for example, can be arranged to the main jib. For example, the hooking tool can be arranged to a work jib, the chain claw can be arranged to its own work jib and the wire twister can also be arranged to its own work jib. In principle, as many work jibs can be arranged to the main jib as is wanted or practically possible.

The FIGS. 4a-4c show details of a wire twister 24 mounted to the second work jib 18 of the crane, in accordance with the invention, in different positions, where the wire twister 24 is arranged to grip and hold a wire or the like, and also turn, lift and/or move said wire. As can be seen, the wire twister 24 comprises a rotary and mounted body 48 that can be rotated about its mounting point. The rotary body 48 encompasses a lower part with a longitudinal groove or cut out 50 that is arranged to receive and hold fast a wire 56 or the like. The groove or cut out 50 is preferably formed in a V or U shape. The holding fast of the wire can be carried out with the help of a pressure cylinder 52 or piston, so that an outwardly extending part of the pressure cylinder, or a mounted part, is forced against the wire 56. The pressure cylinder, or the mounted part, can be controlled or contain equipment so that the force against the wire is held within what is desirable, so that the wire is not damaged. Correspondingly, a pressure cylinder 54 can be used to rotate said body 48 to a desired position, as shown in the respective FIGS. 4a-4c.

The FIGS. 5a-5d show details of a chain claw 22 mounted to the second work jib 18 of the crane, in accordance with the invention, in different positions, where the chain claw 22 is arranged to grip and hold fast chains, chain loops, shackles, etc. The chain claw 22 is preferably formed with at least a partially U-shape, and comprises an upper moveable jaw part 36 and a lower stationary jaw part 38, to receive and hold fast a chain or the like.

The upper jaw part 36 can comprise one or more tooth-like protrusions 46 that are arranged to fit into one or more links 40 of a chain. A pressure cylinder 44 is preferably used to open and close the jaw part 36. In one embodiment, the upper jaw part 36 can be articulately connected 42 in an area adjoining an inner part of the chain claw 22, so that the upper jaw part 36 is partially rotated and opened/closed. Alternatively, the upper jaw part can glide in a groove or the like to provide an upward and downward opening and closing movement.

FIG. 6 shows an alternative embodiment of a hooking tool, in accordance with the invention, and the FIGS. 7a-7d show details of the tool shown in FIG. 6, in different positions. In this embodiment, the extension 21 is formed as an extended pipe-formed body mounted to or integrated with the outwardly extending end 17, and comprises a through groove 64 that extends, at least partially, in the longitudinal direction of the body. Arranged in or to the extension 21, is a rotating mechanism 66 which is arranged to rotate the hook-formed body 35 from a retracted and inactive position to an extended and active position. The rotating mechanism 66 is arranged inside the pipe-formed body, and comprises a closed, articulated connection 68 coupled to a pressure cylinder 70, and the hook formed body 35 is fastened to one of the links in the articulated connection 68. The hook formed body 35 can thereby be led from the inactive position to an active hooking position and further to an active locking position. Other rotating mechanisms than those mentioned here can, of course, be used.

The described tools, i.e. the hooking tool 34, the chain claw 22 and the wire twister 24, as shown and described with reference to the figures, can also be used on any type of crane and the like onboard a vessel to carry out the work operations that are described here.

In the following, the different operations with the help of the anchor handling crane and the tools according to the invention shall be described.

Lifting and Pulling:

The one work jib 16 (the lifting jib) is, as mentioned, equipped with a winch 20 that can carry out normal lifting operations. By sizing the cranes for the commonly heaviest loads, the need for other cranes onboard is eliminated. The lifting capacity can be increased in that two cranes lift at the same time. In addition to normal lifts, the jib 16 can be lowered down to the deck level, and the winch 20 can then be used to pull chains, shackles, wire coils, and other equipment. For heavier work, tugger winches can be used.

Centring of Chain and Wire:

The lifting jib 16 is, as mentioned, also equipped with a hooking tool 34 that is built in an extension 21 of the lifting jib 16. This extension 21 of the jib 16 can be used to push wire and chain across the ship, for example, to be placed between towing pins or in the centre of a shark's mouth. This can be carried out quickly without the crew having to go up to bend the shackle or wire.

Receiving the PCP:

The hooking tool 34 in the extension 21 of the lifting beam 16 has, as mentioned, three positions: open (retracted), semi-open (hooking position) and closed. When receiving PCP, the hooking tool 34 is set at semi-open, and the forerunner will then be easy to catch in that it glides along the lifting jib 16 and stops in the hooking tool 34. As soon as this has happened, the hooking tool 34 is closed, and the forerunner can then be led across the deck between the towing pins or another position. The whole operation can be carried out with no people being present.

Pick Up of a Buoy:

During this operation, both cranes onboard the vessel are used. The lasso is placed in the hooking tools 34 that are closed. This can be carried out on the deck without risk to the crew. The cranes 10 are manoeuvred back on the rail and are swung behind the stern, and the boat is manoeuvred so that the buoy comes within the reach of the lasso. Both hooking tools 34 are opened simultaneously, and the lasso falls into the sea around the buoy.

Anchor Handling Work:

The second work jib 18 is intended for work with chain, shackle and wire. As mentioned, there is a tool anchorage point 60 at the end of the jib 18 where it is possible to fasten equipment to carry out this work. The tool anchorage point 60 can be flipped so that the tool can be held in a correct position when the jib 18 is moved. It can also rotate 360 degrees to have access from all directions however the crane 10 is standing. If two cranes are being used, both cranes can be equipped with two tools: the chain claw 22 and the wire twister 24. As the tool anchorage point can be rotated 360 degrees, the tool one desires to use can be turned to any working position, and one can swap tools by turning 180 degrees.

Chain Claw:

The chain claw 22 is built to grip and hold chain loops and shackles. It can get a grip however the chain or the shackle is lying on the deck. This can take place without manual assistance. The second crane can also help according to need. When the chain claw 22 has got a grip, the jaws are shut hydraulically, and hold on with a firm grip. Now, the chain or the shackle can be turned, be lifted or be moved according to need. The premise is that the chain is unloaded.

Wire Twister:

The wire twister 24 is constructed to grip and hold wires. In addition, it can turn the wire. It can get access from all angles in the same way as the chain claw 22. When the wire twister 24 has got a grip, the jaws are shut hydraulically, and hold on in a firm grip. The wire can now be turned, be lifted or be moved according to need. The premise is that the wire is unloaded.

Disconnection of the Anchor:

Two cranes in cooperation can be used for the disconnection of the anchor. The one crane grips the shackle with the chain claw 22 and holds it in a firm grip in the right position and at a suitable working height. The other crane grips the wire with the wire twister 24 and adjusts to a right position in relation to the shackle. If there is a twist in the wire, the wire can be turned in the right direction so that the twist between the shackle and the socket is removed, and the bolt in the shackle is free. The two cranes have now a firm grip on both the shackle and the wire, and the crew can safely remove the bolt from the shackle in the usual way. When the bolt is out, the crew can walk at a safe distance, and when it is ready the wire twister is opened, and the wire twists by itself without any risk to the crew.

Connection of the Anchor:

By using two cranes, connection of the anchor can also be made easier and safer. The shackle and wire are locked firmly in different cranes, and placed in the right position in relation to each other at a suitable working height. The work to set the bolt can be carried out easier, quicker and safer than before.

1-20. (canceled)

21. Tool (34) for handling of chains, wires, etc., onboard a vessel, where the tool is mounted to an outer part of a jib of a crane, said crane is arranged on or adjoining a work deck on the vessel, characterized by a closable hooking tool (34) for picking up, releasing and/or pushing of said chains, wires, etc., and where the tool is designed as an extension (21) of the outwardly extending end of the crane, comprising a hook-formed body (35) which is arranged to be pulled into and pushed out from said extension (21),

22. Tool (34) according to claim 21, characterized in that the extension (21) is designed as an extended pipe-formed body mounted to or integrated with the outwardly extended end of the crane, and comprises a through groove (64) that runs, at least partially, in the longitudinal direction of the body, and that a mechanism (66) which is arranged to rotate the hook-formed body (35) from a retracted and inactive position to an extended and active position, is arranged in or to the extension (21).

23. Tool (34) according to claim 22, characterized in that said mechanism (66) is arranged in the pipe-formed body, and comprises a closed articulated connection (68) coupled to a pressure cylinder (70), and that the hook-formed body (35) is fastened to one of the links in the articulated connection (68), whereby the hook-formed body (35) is arranged to be guided from the inactive position to an active hooking position and possibly further to an active locking position.

24. Tool (22) for handling of chains, wires, etc., onboard a vessel, where the tool is mounted to an outer part of a jib of a crane, said crane is arranged on or adjoining o a work deck on the vessel, characterized by a chain claw (22) that is arranged to grip and hold chains, chain loops, shackles, etc., where said chain claw (22) is designed in an at least partial U-shape, comprising an upper, moveable jaw part (36) and a lower stationary jaw part (38), to receive and to hold a chain or the like.

25. Tool (22) according to claim 24, characterized in that the upper chain part (36) is articulately connected (42) in an area adjoining an inner part of the chain claw (22), where the upper jaw part (36) comprises a tooth-like protrusion (46) arranged to fit into a link (40) of a chain, and that the upper jaw part (36) is driven by a pressure cylinder (44).

26. Tool (24) for handling of chains, wires, etc., onboard a vessel, where the tool is mounted to an outer part of a jib of a crane, said crane is arranged on or adjoining a work deck on the vessel, characterized by a wire twister (24) that is arranged to grip and hold a wire or the like, and also to turn, lift and/or move said wire, and where the wire twister (24) comprises a rotary, mounted body (48) encompassing a lower part with an longitudinal groove or cut out (50) arranged to receive and hold fast a wire (56) or the like.

27. Tool (10) according to claim 26, charaterised in that the wire twister (24) comprises a number of pressure cylinders or pistons (52) arranged to hold the wire (56), and also a pressure cylinder (54) to rotate said body (48) to different positions.
